(19) United States
(12) Patent Application Publication
(10) Pub. No.: US 2025/0102829 A1
(43) Pub. Date: Mar. 27, 2025

(54) Optimized Posterior Surface for Toric Contact Lenses

(71) Applicant: Johnson & Johnson Vision Care, Inc., Jacksonville, FL (US)

(72) Inventors: Pierre-Yves Gerligand, Jacksonville, FL (US); Shahrokh Zeinali, Jacksonville, FL (US)

(21) Appl. No.: 18/373,757

(22) Filed: Sep. 27, 2023

(51) Int. Cl. G02C 7/04

(52) U.S. Cl. CPC G02C 7/041; G02C 7/047

(57) ABSTRACT

A method for improving a reference set of soft toric contact lenses, an improved set of toric contact lenses and an improved toric lens are provided. The method involves identifying geometric characteristics of the reference lenses including at least a target sphere power, a radius of curvature of the posterior surface of the peripheral zone, a lens center thickness, a lens material refractive index, the optic zone diameter and an outer diameter of said transition zone; identifying a reference meridian of the reference set of toric lenses; reducing slope deviations along the reference meridian by adjusting a sag and the radius of curvature of the peripheral zone, and/or increasing the outer diameter of the transitional zone; and creating the improved set of lenses by applying the adjusted sag and radius of curvature, and/or increased outer diameter of the transition zone to all lenses within the improved set of lenses.

### FIELD OF THE INVENTION

The present application relates to the field of ophthalmic lenses for use with astigmatic patients. More specifically, the present application is directed to an optimized back surface design for a family of astigmatic contact lenses.

### BACKGROUND

Myopia or nearsightedness is an optical or refractive defect of the eye wherein rays of light from an image focus to a point before they reach the retina. Myopia generally occurs because the eyeball or globe is too long or the cornea is too steep. A minus or negative powered spherical lens may be utilized to correct myopia. Hyperopia or farsightedness is an optical or refractive defect of the eye wherein rays of light from an image focus to a point after they reach or behind the retina. Hyperopia generally occurs because the eyeball or globe is too short, or the cornea is too flat. A plus or positive powered spherical lens may be utilized to correct hyperopia.

Astigmatism is an optical or refractive defect in which an individual's vision is blurred due to the inability of the eye to focus a point object into a focused image on the retina. Corneal Astigmatism is caused by a non-rotationally symmetric curvature of the cornea. A normal cornea is spherical whereas in an individual with corneal astigmatism, the cornea is not spherical. In other words, the cornea is more curved or steeper in one direction than another, thereby causing an image to be stretched out into two-line foci rather than focused to a single point. A cylindrical lens rather than a spherical lens may be utilized to resolve astigmatism.

Corneal astigmatism may be corrected using a hard or rigid gas permeable contact lens. In this case, a fluid or tear lens may exist between the posterior surface of the rigid contact lens and the cornea. This fluid or tear lens follows or assumes the shape of the back surface of the contact lens. Since the index of refraction of the fluid or tear lens is nearly a match for the cornea, the corneal toricity is optically neutralized or reduced. In these cases, a toric lens will not be required. However, rigid gas permeable contact lenses and hard contact lenses are generally less comfortable than soft or hydrogel contact lenses. Since soft or hydrogel contact lenses wrap around the cornea, a fluid lens is generally not found, and the tear fluid more closely resembles a thin film. In this case, a toric lens design is required.

A toric lens is an optical element having two different powers in two orientations that are perpendicular to one another. Essentially, a toric lens has one power, spherical, for correcting myopia or hyperopia and one power, cylinder, for correcting astigmatism built into a single lens. These powers are created with curvatures oriented at different angles, and that orientation must be maintained relative to the eye. Accordingly, toric contact lenses also include a mechanism to keep the contact lens relatively stable on the eye when the wearer blinks or looks around.

Maintenance of the rotational, on-eye orientation of toric contact lenses may be accomplished by well-known mechanical means such as ballast, peri-ballast, or dual stabilization zones, the latter being described in U.S. Pat. No. 11,281,024 which is incorporated herein by reference.

The front surface of a toric lens usually carries the stabilization features that provide rotational stability of the lens on eye. The back surface of the lens usually carries the cylinder correction. This is a common approach among soft contact lens manufacturers as it provides manufacturability benefits and allows the generation of multiple SKUs with a minimal number of tools, particularly when the manufacturing process relies on injection molding.

The back surface geometry of a contact lens is a critical aspect of the lens as it is in direct contact with the corneoscleral surface of the eye. As such is it desirable to optimize the back surface design relative to the shape of the cornea to minimize contact pressure so as to avoid corneal staining, chafing, abrasions or the like. Beyond optimization for a specific level of cylinder power correction, what is needed is a back surface design for a set of toric contact lenses, where contact pressure is minimized in the corneal region across the entire range of standard marketed cylinder power lenses, and/or where the differential in contact pressure between the lowest and highest cylinder power lenses is reduced.

### SUMMARY OF THE INVENTION

Provided herein is a method for improving a reference set of soft toric contact lenses. Each lens in the reference lens set includes an anterior surface and a posterior surface disposed opposite the anterior surface and adapted to be placed against an eye of a user. The anterior surface and posterior surfaces meet at a lens edge and define a lens diameter. Each lens further includes an optic zone in a central region of the lens surrounding a lens center and having an optic zone diameter. At least within the optic zone, the posterior surface includes a sphere meridian defining a sphere power for the lens, and a cylinder meridian defining a cylinder power for the lens within a predetermined range of cylinder powers. The lens further includes a peripheral zone in a peripheral region of the lens extending to the lens edge and a transition zone extending between the optic zone and the outer zone. The method for improving includes the steps of identifying geometric characteristics of a target lens within the reference set of lenses, including at least a target sphere power, a radius of curvature of the posterior surface of the peripheral zone, a lens center thickness, a lens material refractive index, the optic zone diameter and an outer diameter of said transition zone; identifying a reference meridian of the reference set of toric lenses, reducing slope deviations along the reference meridian by adjusting a sag and the radius of curvature of the peripheral zone, and/or increasing the outer diameter of the transitional zone, and creating the improved set of lenses by applying the adjusted sag and radius of curvature, and/or increased outer diameter of the transition zone to all lenses within the improved set of lenses.

The reference meridian may be selected from the group consisting of: a meridian having a cylinder power corresponding to the middle of the predetermined range of cylinder powers, a meridian having half of a maximum cylinder power within said predetermined range of cylinder powers, or a meridian having a median radius of curvature between a radius of curvature of the sphere meridian and a radius of curvature of the cylinder meridian for the maximum cylinder power within the range of cylinder powers.

In one embodiment, a total slope deviation range along the posterior surface of the improved set of lenses is reduced as compared to a total slope deviation range along the posterior surface of the reference set of lenses. The difference in a magnitude of a negative slope deviation range within the total slope deviation range and a magnitude of a positive slope deviation range within the total slope deviation range may be reduced in the improved set of lenses as compared to the reference set of lenses.

Further, a maximum corneal pressure of the improved set of lenses may be less than a maximum corneal pressure of the reference set of lenses.

According to various embodiments, the maximum differential in corneal pressure of the lenses within the improved set of lenses may be 0.2 kPa, the lens diameter may be 14.0-14.6 mm, and/or the optic zone diameter may be approximately 9 mm.

According to other various embodiments, the radius of curvature of the sphere meridian and the target sphere power of the reference lens may be 8.35-8.45 mm and −3.0D respectively.

The index of refraction of the reference lens may be 1.42, and the center thickness of the reference lens may be 80 microns.

Also provided herein is a set of toric contact lenses for a predetermined range of cylinder powers. Each lens in the set includes an anterior surface, a posterior surface disposed opposite said anterior surface and adapted to be placed against an eye of a user, where the anterior and posterior surface meet at a lens edge and define a lens diameter. Each lens further includes an optic zone in a central region of the lens surrounding a lens center, a peripheral zone in a peripheral region of the lens extending to the lens edge, and a transition zone extending between the optic zone and the peripheral zone. The posterior surface includes within the optic zone a sphere meridian defining a power for the lens and a cylinder meridian defining a cylinder power for the lens, and a radius of curvature of the sphere meridian. Each lens in the lens set has an outer diameter of 14.0-14.6 mm, an outer diameter of the transition zone that is greater than 13.3 mm, and a sag of the peripheral region that is less than 0.70 mm.

The set of toric lenses may have a maximum differential in corneal pressure for all lenses within the lens set that is less than 0.2 kPa. Each lens in the set may further have an optic zone outer diameter of approximately 9 mm, and/or each lens in the set may have a back curve radius of 8.35-8.45 mm.

Also provided herein is a set of toric contact lenses for a predetermined range of cylinder powers, wherein each lens in the set includes an anterior surface, a posterior surface disposed opposite said anterior surface and adapted to be placed against an eye of a user, where the anterior and posterior surface meeting at a lens edge defining a lens diameter. Each lens further includes an optic zone in a central region of the lens surrounding a lens center, a peripheral zone in a peripheral region of the lens extending to the lens edge, and a transition zone extending between the optic zone and the peripheral zone. The posterior surface includes within the optic zone a sphere meridian defining a power for the lens and a cylinder meridian defining a cylinder power for the lens, and a radius of curvature of the sphere meridian. An area of the transition zone of the toric contact lens is greater than 46% of an overall area of the toric contact lens.

According to various embodiments, the maximum differential in corneal pressure for all lenses within the lens set may be less than 0.2 kPa, the optic zone outer diameter of each lens may be approximately 9 mm, the back curve radius of each lens may be 8.35-8.45 mm, and/or for each lens an area of the transition zone of the toric contact lens may be about 46-55% of an overall area of the toric contact lens.

Also provided is toric contact lens including an anterior surface, a posterior surface disposed opposite said anterior surface and adapted to be placed against an eye of a user, where the anterior and posterior surface meet at a lens edge define a lens diameter. The toric contact lens further includes an optic zone in a central region of the lens surrounding a lens center, a peripheral zone in a peripheral region of the lens extending to the lens edge, and a transition zone extending between the optic zone and the peripheral zone. The posterior surface includes within the optic zone a sphere meridian defining a power for the lens and a cylinder meridian defining a cylinder power for the lens, and a radius of curvature of the sphere meridian. The toric contact lens has an outer diameter of 14.0-14.6 mm, an outer diameter of the transition zone that is greater than 13.3 mm, and a sag of the peripheral region that is less than 0.70 mm.

The cylinder power of the lens may range from −0.75D to −2.75D. The maximum differential in corneal pressure for the lens may be less than 0.2 kPa. Further, the optic zone outer diameter may be approximately 9 mm, and/or the back curve radius of the lens may be 8.35-8.45 mm.

Further, a toric contact lens is also provided including an anterior surface, a posterior surface disposed opposite said anterior surface and adapted to be placed against an eye of a user, where the anterior and posterior surface meeting at a lens edge defining a lens diameter. The toric contact lens further includes an optic zone in a central region of the lens surrounding a lens center, a peripheral zone in a peripheral region of the lens extending to the lens edge, and a transition zone extending between the optic zone and the peripheral zone. The posterior surface includes within the optic zone a sphere meridian defining a power for the lens and a cylinder meridian defining a cylinder power for the lens, and a radius of curvature of the sphere meridian. An area of the transition zone of the toric contact lens is greater than 46% of an overall area of the contact lens.

According to alternate embodiments, the cylinder power of the lens may range from −0.75D to −2.75D, and a maximum differential in corneal pressure for the lens may be less than 0.2 kPa. Further, the optic zone outer diameter may be approximately 9 mm, the back curve radius of the lens may be 8.35-8.45 mm, and/or the area of the transition zone of the toric contact lens may be about 46-55% of an overall area of the toric contact lens.

### BRIEF DESCRIPTION OF THE DRAWINGS

The foregoing and other features and advantages of the invention will be apparent from the following, more particular description of preferred embodiments of the invention, as illustrated in the accompanying drawings.

FIG. 1 illustrates an exemplary toric soft contact lens having dual stabilization zones for providing rotational stability of the lens on eye;

FIG. 2 is a flow diagram illustrating exemplary steps for designing an optimized lens as described herein;

FIG. 3 shows the posterior surface slope deviation for a reference 14.30 mm soft toric contact lens to be improved as described herein;

FIG. 4 illustrates the linear relationship between cylinder correction and radius of curvature along the cylinder meridian for the lens of FIG. 3;

FIG. 5 shows the posterior surface slope deviation of an exemplary embodiment of an improved 14.30 mm lens according to the present invention;

FIGS. 6-7 illustrate pressure maps for the lens of Table 1 herein;

FIGS. 8-9 illustrate pressure maps for the lens of Table 2 herein;

FIG. 10 illustrates an exemplary toric soft contact lens having a ballast type stabilization zone design for providing rotational stability of the lens on eye;

FIG. 11 shows the posterior surface slope deviation for another 14.00 mm reference soft toric contact lens to be improved as described herein;

FIG. 12 shows the posterior surface slope deviation for another embodiment of an improved 14.00 mm lens according to the present invention;

FIG. 13 shows the posterior surface slope deviation for another reference 14.60 mm soft contact lens to be improved as described herein; and

FIG. 14 shows the posterior surface slope deviation for another embodiment of an improved 14.60 mm lens according to the present invention.

### DETAILED DESCRIPTION OF THE INVENTION

As noted above, the back surface geometry of a contact lens is a critical aspect of the lens as it is in direct contact with the surface of the eye. For toric lenses, due to the large number of SKUs, these lenses are typically provided with only one base curve, as opposed to the two or more base curves that are typically offered for spherical lenses and that enable practitioners to better optimize the lens fit on eye for a given patient. For toric lenses, since only one base curve is offered, the radius along the sphere meridian is selected to provide a good fit across the entire population, for example 8.45 mm.

For any contact lens, vision correction is driven by the refractive index of the lens material, the lens center thickness and the geometry of the anterior and posterior surfaces in the central viewing region of the lens. Typically, the radial geometry of a lens is defined by three distinct regions or zones. The inner region or zone is the optic zone that provides vision correction, and the outer or peripheral region or zone is the region of the lens that provides mechanical stability of the lens on eye, and the intermediate or transitional region or zone between the optic zone and peripheral zone blends the two regions together. Discontinuities as between these regions can affect comfort or otherwise cause unwanted optical effects such as scatter.

There are multiple ways of creating the optical zone of the posterior surface that provides the cylinder correction. The two most common are toric surfaces and atoric surfaces (also described as asphero-toric surfaces). The general mathematical description of such surfaces is defined below where equation 1 describes a toric surface and equation 2 describes an atoric surface:

$$Z = \frac{{C}_{x} \cdot {x}^{2} + {C}_{y} \cdot {y}^{2}}{1 + \sqrt{1 - {C}_{x} \cdot {x}^{2} - {C}_{y} \cdot {y}^{2}}} \qquad ( 1 )$$

$$Z = \frac{{C}_{x} \cdot {x}^{2} + {C}_{y} \cdot {y}^{2}}{1 + \sqrt{1 - ( 1 + {k}_{x} ) \cdot {C}_{x} \cdot {x}^{2} - ( 1 + {k}_{y} ) \cdot {C}_{y} \cdot {y}^{2}}} \qquad ( 2 )$$

where Z (sagittal value), x, and y are the coordinates of the surface in a cartesian coordinate system, C_{X}=1/Rₓ, C_{y}=1/R_{y}, Rₓ and R_{y} are the apical radius along the X-axis and the Y-axis, and k_{X} and k_{y} are the conic constants relative to the X-axis and the Y-axis. For clarity purpose the sphere power correction is by convention built along the X-axis while the cylinder correction is built along the Y-axis. This convention will be applied herein.

The peripheral zone of the back surface of a toric lens is typically a spherical surface and is usually rotationally symmetric around the optical axis. In some instances, the back surface of the peripheral zone can be more complex, such as an aspheric surface.

The present disclosure provides an optimized back surface design that achieves reduced contact pressure across a predetermined range of cylinder power lenses as compared to prior designs. The present disclosure also provides a system and method for designing such lenses to achieve such improvement as compared to a reference set of known lenses.

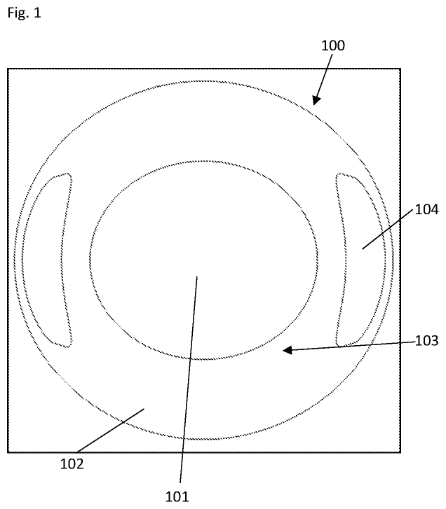

Referring now to FIG. 1, as noted above an exemplary lens 100 that can be optimized according to the present disclosure has an inner optic zone 101, and a peripheral zone 102 that includes stabilization features 104. In the illustrated embodiment, the stabilization design includes dual stabilization zones 104, although any stabilization zone design may be used. Although its boundaries are not expressly illustrated in FIG. 1, a transitional zone 103 exists between the optic zone and the peripheral zone that is designed to blend the two together. The transitional zone is defined as a spline providing surface continuity in Sag and slope.

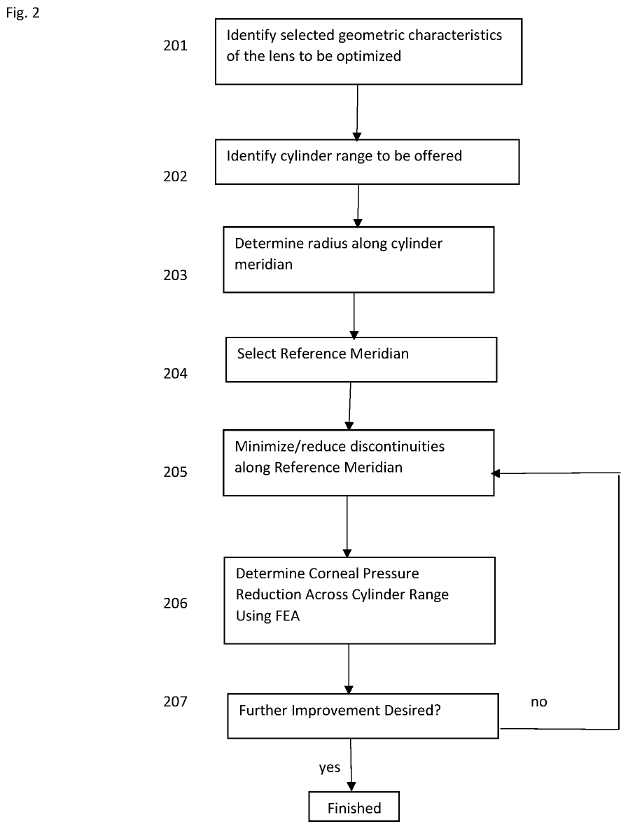

A posterior surface of a lens, or set of lenses, of the type illustrated in FIG. 1 can be optimized according to the present disclosure to reduce corneal pressure across a predetermined range of cylinder powers. As a first step 201 (FIG. 2), geometric characteristics of the lens to be optimized are identified. Table 1 below describes the back surface geometrical characteristics of a known toric contact lens of the type illustrated in FIG. 1 having dual stabilization zones that was used as a starting point in the optimization process described herein.

### Back Surface

TABLE 1

| Description | Radius | Diameter | Shape (K) | Sag | X-Ctr | Z-Ctr | X-End |
|---|---|---|---|---|---|---|---|
| Radius SPHERE | 8.450 | 9.00 | 0.000 | 1.298 | 0.000 | 8.525 | 4.500 |
| Meridian | | | | | | | |
| Radius Cylinder | 8.325 | 9.00 | 0.000 | 1.321 | 0.000 | 8.400 | 4.500 |
| Meridian (−0.75 D) | | | | | | | |
| Radius Cylinder | 8.009 | 9.00 | 0.000 | 1.384 | 0.000 | 8.084 | 4.500 |
| Meridian (−2.75 D) | | | | | | | |
| Blending Region | Spline | 11.80 | — | Varies | — | — | 5.900 |
| | | | | with | | | |
| | | | | cylinder | | | |
| Peripheral Region | 8.500 | 14.30 | 0.000 | 1.504 | 0.038 | 8.634 | 7.152 |

The radius of curvature along the sphere meridian is 8.45 mm, the target sphere power correction is −3.0D, the lens center thickness is 80 microns, and the lens material refractive index is 1.42. The optic zone has a diameter of 9.0 mm, the lens outer diameter is 14.3 mm, and the initial diameter of the outer edge of the transition zone is 11.80 mm. A predetermined range of cylinder powers to be offered is then identified 202, which in this example is −0.75D to −2.75D. Those skilled in the art will readily recognize that the back radius along the cylinder meridian of the lens to be optimized can be determined 203 using any ray tracing method once the material refractive index, center thickness, targeted sphere power (−3.0D) and radius of curvature (8.45 mm) along the sphere meridian are established. In this example, the front surface geometry includes the dual stabilization zones having a maximum radial thickness of 375 microns which is kept constant, although other variations may be incorporated, including designs having varying thickness differentials according to cylinder power, for example, as is described in U.S. Pat. No. 10,739,617 which is incorporated herein by reference in its entirety.

Starting with these geometric characteristics of a reference lens within the set to be optimized, the next step in the optimization process is to select a reference meridian 204 on the posterior surface. The reference slope is defined as the surface slope calculated along that reference meridian for which the posterior surface is to be optimized. The reference meridian can be selected as the meridian carrying the cylinder power corresponding to the middle of the cylinder range across which the surface is optimized. For example, if the cylinder range to be optimized is −0.75D to −2.75D, the reference meridian can be the meridian carrying a −1.75D cylinder power. Alternatively, the reference meridian can be selected as the meridian carrying half of the maximum targeted cylinder power (i.e., −1.375D if the maximum targeted cylinder power is −2.75D). The reference meridian can alternatively be selected as the meridian carrying the mean radius between the radius of curvature along the sphere power meridian and the radius of curvature along the maximum targeted cylinder power.

If the posterior optic zone is defined by a more complex atoric surface, the radius of curvature along a given meridian can be replaced by the equivalent radius, which is defined by a circle of radius R fit through 3 points of a lens diametric cross-section. The three points are the sagittal apex at the lens center and the two end points of the chord over which the sagittal measurements (Z) are made.

Once the reference meridian is selected, it is then optimized to minimize or balance slope discontinuities between the optic zone and the transition zone, and the transition zone and the peripheral zone (step 205). Minimization or balancing is achieved by (1) adjusting the Sag and the radius of curvature in the outer peripheral zone, and/or (2) increasing the width of the transitional zone. The wider the transitional zone is the smoother the transition is between the optic zone and the peripheral zone.

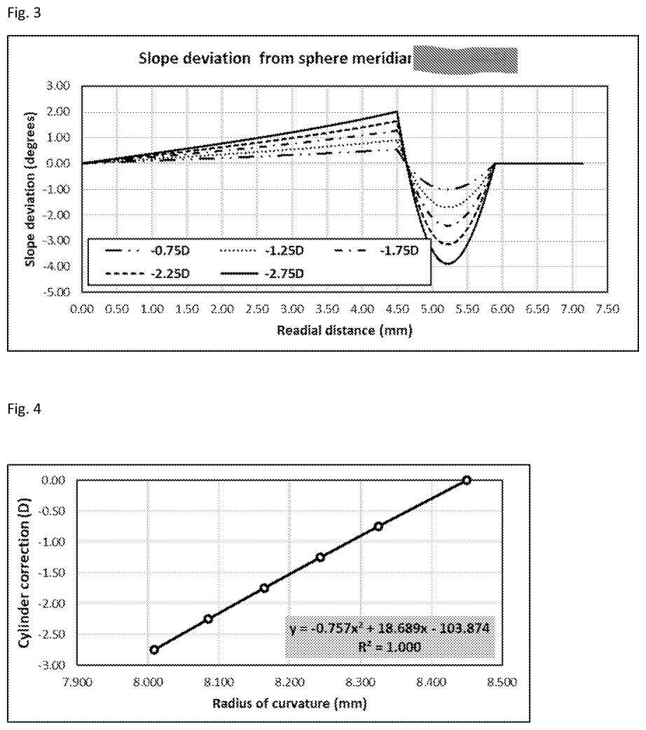

For a set of lenses within a predetermined range of cylinder powers, discontinuities will increase with an increase in cylinder correction due to the curvature getting steeper along the cylinder meridian. The slope deviations calculated for the lens having the geometrical characteristics set forth in Table 1 are shown in FIG. 3. Slope deviation is defined as the difference in surface slope between the sphere meridian and the cylinder meridian calculated from the lens geometrical center to the lens edge. As shown in FIG. 3, the slope deviation increases in a linear fashion from the lens center toward the edge of the optic zone, reaching a maximum value of 2.0 degrees for the −2.75D cylinder correction. The slope deviation is the opposite in the intermediate or blending region reaching a maximum value of about −4.0 degrees for the −2.75D cylinder correction, then tempers down to zero in the outer region of the periphery as the geometry of this region along with the circumference of the lens remains identical across the cylinder range. For purposes of this application, positive slope deviation refers to slope deviation having a positive value, and the maximum positive slope deviation is the largest positive slope deviation value (i.e, in this instance 2.0). Similarly, negative sloe deviation refers to deviation having a negative value, and the maximum negative deviation is the largest negative slope deviation value (i.e., in this instance −4.0).

As noted, the discontinuities and/or slope deviations can be minimized by adjusting the sag and the radius of curvature of the peripheral zone, increasing the width of the transition zone, or a combination, along the selected reference meridian, which in this embodiment has been chosen as the meridian at the middle of the cylinder range (−1.75D). In the present exemplary embodiment, the Sag and the radius of curvature of the peripheral zone is adjusted to 0.67 mm and 8.65 mm respectively, and the outer diameter of the transition zone is increased to 13.30 as shown in Table 2 below.

### Back Surface

TABLE 2

| Description | Radius | Diameter | Shape (K) | Sag | X-Ctr | Z-Ctr | X-End |
|---|---|---|---|---|---|---|---|
| Radius SPHERE | 8.450 | 9.00 | 0.000 | 1.298 | 0.000 | 8.525 | 4.500 |
| Meridian | | | | | | | |
| Radius Cylinder | 8.325 | 9.00 | −0.036 | 1.317 | 0.000 | 8.707 | 4.500 |
| Meridian (−0.75 D) | | | | | | | |
| Radius Cylinder | 8.009 | 9.00 | −0.124 | 1.366 | 0.000 | 9.213 | 4.500 |
| Meridian (−2.75 D) | | | | | | | |
| Blending Region | Spline | 13.30 | — | Varies | — | — | 6.650 |
| | | | | with | | | |
| | | | | cylinder | | | |
| Peripheral Region | 8.6560 | 14.30 | 0.000 | 0.667 | 0.000 | 8.847 | 7.152 |

Due to the strong linear relationship between the radius of curvature along the cylinder meridian and the corresponding built in astigmatism correction for this example as shown in FIG. 4, the optimized reference meridian will be almost identical regardless of whether the reference meridian is chosen as that carrying half of the maximum targeted cylinder or that of the median radius between the radius of curvature along the sphere power meridian and the radius of curvature along the maximum targeted cylinder power. The former yields a radius of curvature of 8.224 mm and the latter 8.229 mm. The results from the two methods may show larger disparities if the back surface geometries across the targeted cylinder range do not have a linear relationship with the radius of curvature (i.e., more complex geometries such as free form surfaces intended to correct higher order aberrations). In such instances, the radius of curvature can be replaced by an equivalent radius of curvature along the cylinder meridian.

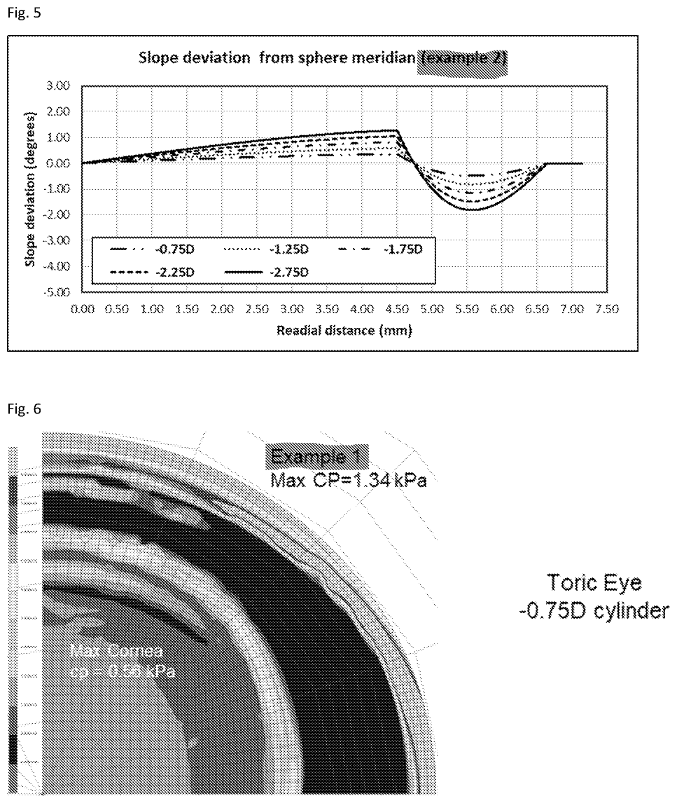

Slope deviations for the geometries set forth in Table 2 are shown in FIG. 5. As illustrated, the slope deviation increases in a linear fashion from the lens center to the edge of the optic zone, reaching a maximum value of about 1.25 degrees for the −2.75D cylinder correction. The slope deviation reverses in the transition zone reaching a maximum value of about −2.0 degrees for the −2.75D cylinder correction, then tempers down to zero in the peripheral zone of the lens as the geometry in this region along the circumference of the lens remains identical across the cylinder range. The back surface geometry of the lens defined in Table 2 significantly reduces the slope deviation as a result of the aspherization of the back optical region, the increase of the transition zone width, and the selection of the −1.75D cylinder meridian as the optimized reference meridian. In the provided example, the back surface geometry balances the slope deviation range within the transition zone such that the maximum negative deviation does not differ as much from the maximum positive deviation. Preferably, the maximum negative deviation will be smaller in magnitude than the maximum positive deviation, but this may not always be possible with all lens geometries (i.e., optic zone diameter and the maximum targeted cylinder power).

The introduction of asphericity along the cylinder meridian as shown in Table 2 (non null K values along the cylinder meridians) reduces the surface curvature leading to a smaller slope deviation at the optic zone—transition zone boundary.

Another benefit of aspherization of the cylinder meridian of the back optical region is that it can reduce secondary astigmatism, which is a result of the difference in spherical aberration along the sphere and cylinder meridians. Reducing secondary astigmatism can improve vision as is described in detail in U.S. Patent Application No. 2019/0064543, which is incorporated herein by reference in its entirety.

As part of the optimization process, the new design is then assessed to determine the contact pressure in the corneal region of the lens when wrapped on eye using a Finite Element Analysis (FEA) model (step 206). A FEA model simulates the wrapping of a soft contact lens on eye and provides a contact pressure map as an output for any given lens cylinder power. FEA models of wrapping of soft contact lenses with reference (Table 1) and optimized (Table 2) designs on rigid surfaces of two average eye geometries with low cylinder (−0.75D) and high cylinder (−2.75D) levels were developed, and the lens-eye contact pressure were computed. A wrapping pressure of 0.2 kPa applied on the back surface of the lens, a modulus of elasticity of 660 kPa, a Poisson's ratio of 0.244, and either a quarter symmetry or half symmetry fixed boundary conditions were assumed in the model for dual stabilization zone or ballasted type stabilization zone designs respectively. Proper boundary conditions at symmetry planes prevent the lens from decentering on the eye surface such that the center of the lens is aligned with the apex of the cornea throughout the wrapping deformation. Table 3 below summarizes the eye geometries defined for the rigid eye model:

TABLE 3

| | |
|---|---|
| Low Cyl. Eye | High Cyl. Eye |

| | | |
|---|---|---|
| Equivalent Cyl. Power | −0.75D | −2.75D |

| | | | | |
|---|---|---|---|---|
| Corneal Diameter | 12.20 | mm | 12.20 | mm |
| Scleral Diameter | 20.0 | mm | 20.0 | mm |
| CS Junction Fillet Radius | 10.0 | mm | 10.0 | mm |
| Apical Radius 180 deg. | 7.86 | mm | 7.86 | mm |
| Apical Radius 90 deg. | 7.733 | mm | 7.414 | mm |

| | | |
|---|---|---|
| Shape Factor | −0.26 | −0.26 |

| | | | | |
|---|---|---|---|---|
| Sclera Radius | 12.0 | mm | 12.0 | mm |

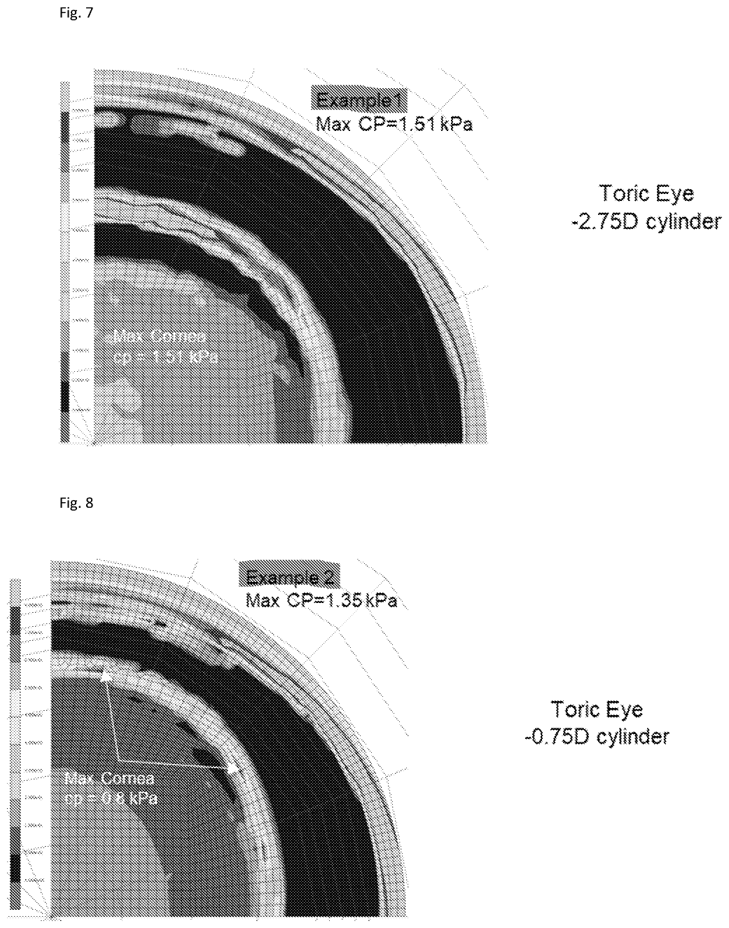

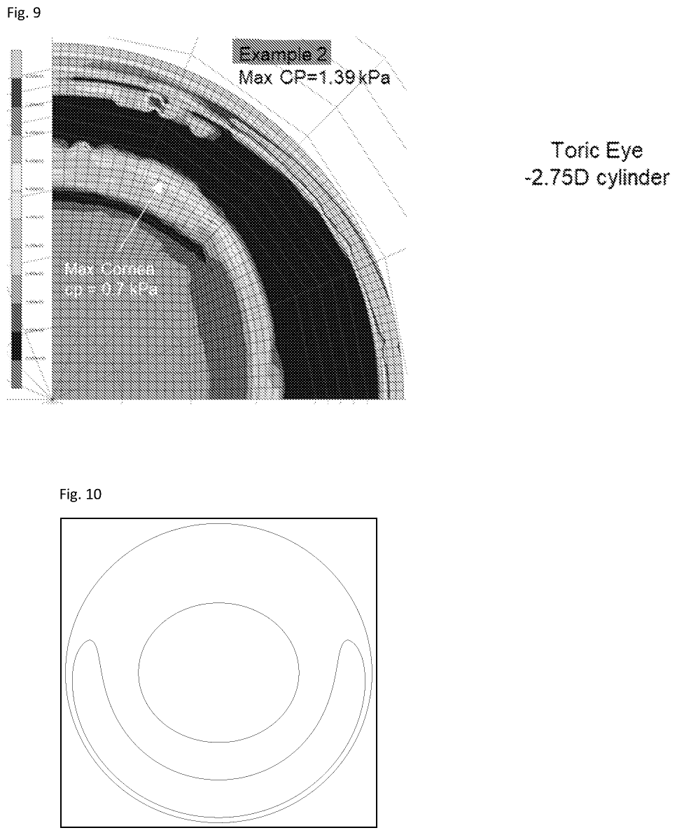

FIGS. 6, 7, 8 and 9 illustrate the pressure map output for the lens defined by Table 1 with −0.75D cylinder power and −2.75D cylinder power, and that of Table 2 for the same cylinder powers respectively.

Table 4 below shows the maximum corneal pressure and maximum corneoscleral pressure as determined by the FEA at the low end of the cylinder range (−0.75D) and the high end of the cylinder range (−2.75D) for the reference lens defined by Table 1 above, and the improved design defined by Table 2 above. As shown, the maximum corneal pressure (CP) is reduced from 1.51 kPa to 0.70 kPa for the highest cylinder correction, and the maximum corneoscleral pressure (CSP) range remains below 1.40 kPa for the highest cylinder correction. In addition to reducing the maximum pressure across the cylinder range, the improved lens also reduces the differential in contact pressure between the lowest and highest cylinder power lenses. For example, as shown below the corneal pressure differential for the lens of Table 2 has been reduced from 0.95 kPa (1.51-0.56) to 0.1 kPa (0.80-0.70), and the corneoscleral pressure differential has been reduced from 0.17 kPa to 0.04 kPa.

It is noted that in the improved lens, the outer diameter of the transition zone has increased from 11.8 to 13.3, and since the outer diameter of the lens and the outer diameter of the optic zone remain the same, this represents an increase in the area of the transition zone relative to the area of the entire lens from 28.5% to 46.9%.

TABLE 4

| | Corneoscleral contact pressure (kPa) | | | | | | | |
|---|---|---|---|---|---|---|---|---|
| | ESD type | | | | Ballast type | | | |
| | Lens of Table 1 | | Lens of Table 2 | | Lens of Table 1 | | Lens of Table 2 | |
| | −0.75 D | −2.75 D | −0.75 D | −2.75 D | −0.75 D | −2.75 D | −0.75 D | −2.75 D |
| Maximum corenal | 0.56 | 1.51 | 0.80 | 0.70 | 1.20 | 2.00 | 1.20 | 1.40 |
| pressure (cp) | | | | | | | | |
| Maximum | 1.34 | 1.51 | 1.35 | 1.39 | 1.70 | 2.00 | 1.80 | 1.80 |
| corneoscleral | | | | | | | | |
| pressure (CSP) | | | | | | | | |

Also shown in Table 4 are similar results for a known ballast-type toric lens of the type shown in FIG. 10 having the geometrical characteristic set forth in Table 1 above, as compared to the same lens with the geometrical characteristics shown in Table 2. The maximum thickness of the ballast region was set to the same value as used for the dual stabilization zone example. As shown in Table 4, when optimized in accordance with the present disclosure, the maximum corneal contact pressure is substantially reduced (from 2.0 kPa to 1.4 kPa) for a high cylinder lens while the maximum corneoscleral pressure remains at 1.80 kPa across the full range of cylinder powers.

The output of the FEA analysis is reviewed in step 207. If a desired level of reduction in corneal pressure across the cylinder power range has not been achieved, step 205 can be repeated to further minimize discontinuities as described above.

Table 5 below reflects geometrical characteristics of another example lens that can be further improved according to the present invention. The physical characteristics of the lens to be optimized are the same as described above other than the geometrical differences shown in Table 5, including a smaller diameter lens of 14.0 mm as compared to 14.3 mm in the previous examples.

TABLE 5

| Description | Radius | Diameter | Shape (K) | Sag | X-Ctr | Z-Ctr | X-End |
|---|---|---|---|---|---|---|---|
| Radius SPHERE | 8.350 | 9.00 | 0.000 | 1.316 | 0.000 | 8.425 | 4.500 |
| Meridian | | | | | | | |
| Radius Cylinder | 8.228 | 9.00 | 0.000 | 1.340 | 0.000 | 8.303 | 4.500 |
| Meridian (−0.75 D) | | | | | | | |
| Radius Cylinder | 7.919 | 9.00 | 0.000 | 1.403 | 0.000 | 7.994 | 4.500 |
| Meridian (−2.75 D) | | | | | | | |
| Blending Region | Spline | 11.80 | — | Varies | — | — | 5.900 |
| | | | | with | | | |
| | | | | cylinder | | | |
| Peripheral Region | 8.250 | 14.00 | 0.000 | 1.353 | 0.090 | 8.339 | 7.002 |

Using the principles described above and the same chosen reference meridian, slope deviations along this reference meridian were minimized by adjusting the sag and radius of curvature of the peripheral zone to 0.329 and 11 mm from 1.353 and 8.25 mm respectively. The outer diameter of the transition zone was increased to 13.5 mm from 11.8 mm. The new geometries for this improved lens are shown in Table 6 below.

### Back Surface

TABLE 6

| Description | Radius | Diameter | Shape (K) | Sag | X-Ctr | Z-Ctr | X-End |
|---|---|---|---|---|---|---|---|
| Radius SPHERE | 8.350 | 9.00 | 0.000 | 1.316 | 0.000 | 8.425 | 4.500 |
| Meridian | | | | | | | |
| Radius Cylinder | 8.228 | 9.00 | −0.035 | 1.335 | 0.000 | 8.603 | 4.500 |
| Meridian (−0.75 D) | | | | | | | |
| Radius Cylinder | 7.919 | 9.00 | −0.122 | 1.385 | 0.000 | 9.094 | 4.500 |
| Meridian (−2.75 D) | | | | | | | |
| Blending Region | Spline | 13.50 | — | Varies | — | — | 6.650 |
| | | | | with | | | |
| | | | | cylinder | | | |
| Peripheral Region | 11.000 | 14.01 | 0.000 | 0.329 | −1.842 | 10.375 | 7.152 |

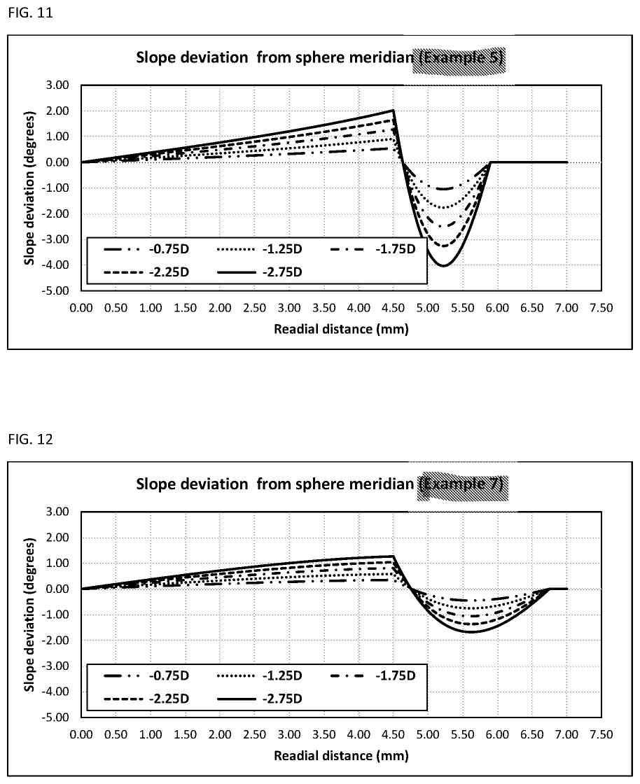

The slope deviations for the geometries set forth in Table 5 and 6 above are shown in FIGS. 11 and 12 respectively. As can be seen for the lens of Table 5, the slope deviation increases in a linear manner from lens center to the edge of the optic zone, reaching a maximum value of about 2 degrees for the −2.75D cylinder correction. The slope deviation reverses in the transition zone reaching a maximum value of about −4.0 degress for the −2.75D cylinder correction, then tempers down to zero in the peripheral zone of the lens as the geometry in this region along the circumference of the lens remains identical across the cylinder range. Thus, for a 14.0 mm diameter lens, reducing/minimizing discontinuities along the reference meridian similarly reduces the slope deviation as compared to the initial or reference lens as a result of the aspherization of the back optical region and the increase in the transition zone width. Further, as with the prior example, the maximum negative slope deviation is closer to the maximum positive slope deviation.

FEA results of the lens of Table 5 and 6 is set forth in Table 7 below.

TABLE 7

| Corneoscleral contact pressure (kPa) | |
|---|---|
| ESD type | |
| Lens of Table 5 | Lens of Table 6 |

| | −0.75D | −2.75D | −0.75D | −2.75D |
|---|---|---|---|---|
| Maximum corneal | 0.85 | 1.59 | 0.80 | 0.72 |
| pressure | | | | |
| Maximum | 1.48 | 1.59 | 1.36 | 1.32 |
| corneoscleral | | | | |
| pressure | | | | |

The maximum corneal pressure across the cylinder range is reduced from 1.59 kPa to 0.80 kPa, and the maximum corneoscleral pressure is reduced from 1.59 kPa to 1.36 kPa. In addition, the maximum corneal pressure differential between the low and high cylinder lenses is reduced from 0.74 kPa to 0.08 kPa, and the maximum corneoscleral pressure differential is reduced from 0.11 kPa to 0.04 kPa.

Further, it is noted that in the improved lens, the outer diameter of the transition zone has increased from 11.8 to 13.5, and since the outer diameter of the lens and the outer diameter of the optic zone remain the same, this represents an increase in the area of the transition zone relative to the area of the entire lens from 29.7% to 51.7%.

Table 8 below reflects geometrical characteristics of another example lens that can be further improved according to the present invention. The physical characteristics of the lens to be optimized are the same as described above other than the geometrical differences shown in Table 8, including a larger diameter lens of 14.6 mm as compared to 14.0 and 14.3 in the examples above.

TABLE 8

| Description | Radius | Diameter | Shape (K) | Sag | X-Ctr | Z-Ctr | X-End |
|---|---|---|---|---|---|---|---|
| Radius SPHERE | 8.450 | 9.00 | 0.000 | 1.298 | 0.000 | 8.525 | 4.500 |
| Meridian | | | | | | | |
| Radius Cylinder | 8.325 | 9.00 | 0.000 | 1.321 | 0.000 | 8.400 | 4.500 |
| Meridian (−0.75 D) | | | | | | | |
| Radius Cylinder | 8.009 | 9.00 | 0.000 | 1.384 | 0.000 | 8.084 | 4.500 |
| Meridian (−2.75 D) | | | | | | | |
| Blending Region | Spline | 11.80 | — | Varies | — | — | 5.900 |
| | | | | with | | | |
| | | | | cylinder | | | |
| Peripheral Region | 8.500 | 14.60 | 0.000 | 1.753 | 0.021 | 8.609 | 7.302 |

Using the principles described above and the same chosen reference meridian, slope deviations along this meridian were reduced by adjusting the sag and radius of curvature of the peripheral zone to 0.373 and 12.0 from 1.753 and 8.5 respectively. The outer diameter of the transition zone was increased from 11.8 mm to 14.10 mm. The new geometries for this improved lens are shown in Table 9 below.

### Back Surface

TABLE 9

| Description | Radius | Diameter | Shape (K) | Sag | X-Ctr | Z-Ctr | X-End |
|---|---|---|---|---|---|---|---|
| Radius SPHERE | 8.450 | 9.00 | 0.000 | 1.298 | 0.000 | 8.525 | 4.500 |
| Meridian | | | | | | | |
| Radius Cylinder | 8.325 | 9.00 | −0.036 | 1.317 | 0.000 | 8.707 | 4.500 |
| Meridian (−0.75 D) | | | | | | | |
| Radius Cylinder | 8.009 | 9.00 | −0.124 | 1.366 | 0.000 | 9.213 | 4.500 |
| Meridian (−2.75 D) | | | | | | | |
| Blending Region | Spline | 14.10 | — | Varies | — | — | 7.050 |
| | | | | with | | | |
| | | | | cylinder | | | |
| Peripheral Region | 12.000 | 14.60 | 0.000 | 0.373 | −2.766 | 10.753 | 7.302 |

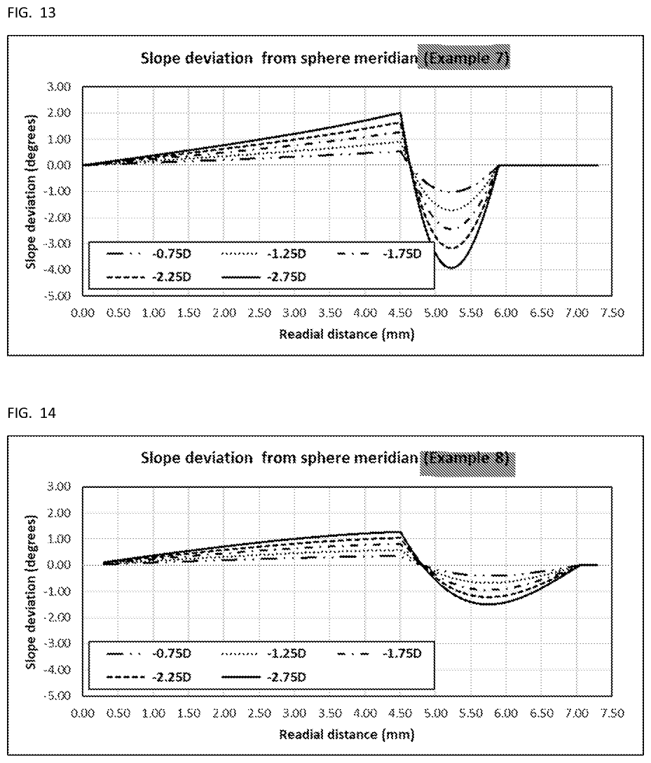

The slope deviations for the geometries set forth in Tables 8 and 9 above are shown in FIGS. 13 and 14 respectively. As can be seen for the lens of Table 9, the slope deviation increases in a linear manner from lens center to the edge of the optic zone, reaching a maximum value of about 1.25 degrees for the −2.75D cylinder correction. The slope deviation reverses in the transition zone reaching a maximum value of about −1.50 degrees for the −2.75D cylinder correction, then tempers down to zero in the peripheral zone of the lens as the geometry in this region along the circumference of the lens remains identical across the cylinder range. Thus, for a 14.6 mm diameter lens, reducing/minimizing discontinuities along the reference meridian similarly reduces the slope deviation as compared to the initial or reference lens as a result of the aspherization of the back optical region and the increase in the transition zone width. Further, as with the prior examples, the maximum negative slope deviation is closer to the maximum positive slope deviation.

FEA results of the lens of Table 8 and 9 is set forth in Table 10 below.

TABLE 10

| Corneoscleral contact pressure (kPa) | |
|---|---|
| ESD type | |
| Lens of Table 8 | Lens of Table 9 |

| | −0.75D | −2.75D | −0.75D | −2.75D |
|---|---|---|---|---|
| Maximum corneal | 0.64 | 1.36 | 0.64 | 0.56 |
| pressure | | | | |
| Maximum | 1.81 | 1.36 | 1.70 | 1.83 |
| corneoscleral | | | | |
| pressure | | | | |

The maximum corneal pressure across the cylinder range is reduced from 1.36 kPa to 0.64 kPa, and the maximum corneoscleral pressure only slightly varies at 1.83 kPa compared to 1.81 kPa. The maximum corneal pressure differential between the low and high cylinder lenses is reduced from 0.72 kPa to 0.08 kPa, and the maximum corneoscleral pressure differential is reduced from 0.45 kPa to 0.13 kPa.

Further, it is noted that in the improved lens, the outer diameter of the transition zone has increased from 11.8 mm to 14.1 mm, and since the outer diameter of the lens and the outer diameter of the optic zone remain the same, this represents an increase in the area of the transition zone relative to the area of the entire lens from 27.3% to 55.2%.

While the foregoing is directed to embodiments of the present invention, other and further embodiments of the invention may be devised without departing from the basic scope thereof, which is only limited by the scope of the claims that follow. For example, the present invention contemplates that any of the features shown in any of the embodiments described herein, may be incorporated with any of the features shown in any of the other embodiments described herein, or incorporated by reference herein, and still fall within the scope of the present invention.

What is claimed is:

1. A method for improving a reference set of soft toric contact lenses, wherein
each lens in the reference lens set comprises:
an anterior surface and a posterior surface disposed opposite the anterior surface and adapted to be placed against an eye of a user, the anterior surface and posterior surfaces meeting at a lens edge and defining a lens diameter;
an optic zone in a central region of the lens surrounding a lens center and having an optic zone diameter, wherein at least within the optic zone the posterior surface includes a sphere meridian defining a sphere power for said lens, and a cylinder meridian defining a cylinder power for said lens within a predetermined range of cylinder powers;
a peripheral zone in a peripheral region of the lens extending to said lens edge, and a transition zone extending between the optic zone and the outer zone,
wherein the method for improving comprises the steps of
identifying geometric characteristics of a target lens within said reference set of lenses, including at least a target sphere power, a radius of curvature of the posterior surface of the peripheral zone, a lens center thickness, a lens material refractive index, the optic zone diameter and an outer diameter of said transition zone;
identifying a reference meridian of said reference set of toric lenses; reducing slope deviations along said reference meridian by adjusting a sag and the radius of curvature of the peripheral zone, and/or increasing the outer diameter of the transitional zone; and
creating the improved set of lenses by applying the adjusted sag and radius of curvature, and/or increased outer diameter of the transition zone to all lenses within the improved set of lenses.

2. The method according to claim 1, wherein the reference meridian is selected from the group consisting of:
a meridian having a cylinder power corresponding to the middle of the predetermined range of cylinder powers,
a meridian having half of a maximum cylinder power within said predetermined range of cylinder powers, or
a meridian having a median radius of curvature between a radius of curvature of the sphere meridian and a radius of curvature of the cylinder meridian for the maximum cylinder power within said range of cylinder powers.

3. The method of claim 2, wherein a total slope deviation range along the posterior surface of the improved set of lenses is reduced as compared to a total slope deviation range along the posterior surface of the reference set of lenses.

4. The method according to claim 3, wherein a difference in a magnitude of a negative slope deviation range within the total slope deviation range and a magnitude of a positive slope deviation range within the total slope deviation range is reduced in the improved set of lenses as compared to the reference set of lenses.

5. The method according to claim 1, wherein a maximum corneal pressure of the improved set of lenses is less than a maximum corneal pressure of the reference set of lenses.

6. The method according to claim 1, wherein the maximum differential in corneal pressure of the low cylinder and high cylinder lenses within the improved set of lenses is 0.2 kPa.

7. The method according to claim 1, wherein the lens diameter is 14.0-14.6 mm.

8. The method according to claim 7, wherein the optic zone diameter is approximately 9 mm.

9. The method according to claim 8, wherein the radius of curvature of said sphere meridian and said target sphere power of said reference lens are 8.35-8.45 mm and −3.0D respectively.

10. The method according to claim 9, wherein the index of refraction of said reference lens is 1.42.

11. The method according to claim 10, wherein the center thickness of said reference lens is 80 microns.

12. A set of toric contact lenses for a predetermined range of cylinder powers, wherein each lens in the set includes an anterior surface, a posterior surface disposed opposite said anterior surface and adapted to be placed against an eye of a user, the anterior and posterior surface meeting at a lens edge defining a lens diameter, an optic zone in a central region of the lens surrounding a lens center, a peripheral zone in a peripheral region of the lens extending to said lens edge, and a transition zone extending between the optic zone and the peripheral zone, the posterior surface comprising within the optic zone a sphere meridian defining a sphere power for said lens and a cylinder meridian defining a cylinder power for said lens, and a radius of curvature of said sphere meridian,
wherein each lens in the set has an outer diameter of 14.0-14.6 mm, an outer diameter of the transition zone that is greater than 13.3 mm, and a sag of the peripheral region that is less than 0.70 mm.

13. The set of toric lenses according to claim 12, wherein a maximum differential in corneal pressure for all lenses within the lens set is less than 0.2 kPa.

14. The set of toric lenses according to claim 12, where each lens in the set has an optic zone outer diameter of approximately 9 mm.

15. The set of toric lenses according to claim 12, where each lens in the set has a back curve radius of 8.35-8.45 mm.

16. A set of toric contact lenses for a predetermined range of cylinder powers, wherein each lens in the set includes an anterior surface, a posterior surface disposed opposite said anterior surface and adapted to be placed against an eye of a user, the anterior and posterior surface meeting at a lens edge defining a lens diameter, an optic zone in a central region of the lens surrounding a lens center, a peripheral zone in a peripheral region of the lens extending to said lens edge, and a transition zone extending between the optic zone and the peripheral zone, the posterior surface comprising within the optic zone a sphere meridian defining a sphere power for said lens and a cylinder meridian defining a cylinder power for said lens, and a radius of curvature of said sphere meridian,
wherein an area of the transition zone of the toric contact lens is greater than 46%. of an overall area of the toric contact lens.

17. The set of toric lenses according to claim 16, wherein a maximum differential in corneal pressure for all lenses within the lens set is less than 0.2 kPa.

18. The set of toric lenses according to claim 16, where each lens in the lens set has an optic zone outer diameter of approximately 9 mm.

19. The set of toric lenses according to claim 16, where each lens in the lens set has a back curve radius of 8.35-8.45 mm.

20. The set of toric lenses according to claim 16, wherein an area of the transition zone of the toric contact lens is about 46-55% of an overall area of the toric contact lens.

21. A toric contact lens, comprising:
an anterior surface, a posterior surface disposed opposite said anterior surface and adapted to be placed against an eye of a user, the anterior and posterior surface meeting at a lens edge defining a lens diameter, an optic zone in a central region of the lens surrounding a lens center, a peripheral zone in a peripheral region of the lens extending to said lens edge, and a transition zone extending between the optic zone and the peripheral zone, the posterior surface comprising within the optic zone a sphere meridian defining a sphere power for said lens and a cylinder meridian defining a cylinder power for said lens, and a radius of curvature of said sphere meridian,
wherein the toric contact lens has an outer diameter of 14.0-14.6 mm, an outer diameter of the transition zone that is greater than 13.3 mm, and a sag of the peripheral region that is less than 0.70 mm.

22. The toric contact lens according to claim 21, wherein the cylinder power of said lens ranges from −0.75D to −2.75D.

23. The toric contact lens according to claim 21, wherein a maximum differential in corneal pressure between the low cylinder and high cylinder lens is less than 0.2 kPa.

24. The toric contact lens according to claim 21, where the optic zone outer diameter is approximately 9 mm.

25. The toric contact lens according to claim 21, where a back curve radius of the lens is 8.35-8.45 mm.

26. A toric contact lens, comprising:
an anterior surface, a posterior surface disposed opposite said anterior surface and adapted to be placed against an eye of a user, the anterior and posterior surface meeting at a lens edge defining a lens diameter, an optic zone in a central region of the lens surrounding a lens center, a peripheral zone in a peripheral region of the lens extending to said lens edge, and a transition zone extending between the optic zone and the peripheral zone, the posterior surface comprising within the optic zone a sphere meridian defining a sphere power for said lens and a cylinder meridian defining a cylinder power for said lens, and a radius of curvature of said sphere meridian,
wherein an area of the transition zone of the toric contact lens is greater than 46% of an overall area of the contact lens.

27. The toric contact lens according to claim 26, wherein the cylinder power of said lens ranges from −0.75D to −2.75D.

28. The toric contact lens according to claim 26, wherein a maximum differential in corneal pressure between the low cylinder and high cylinder lens is less than 0.2 kPa.

29. The toric contact lens according to claim 26, where the optic zone outer diameter is approximately 9 mm.

30. The toric contact lens according to claim 26, where a back curve radius of the lens is 835-8.45 mm.

31. The toric contact lens according to claim 26, wherein an area of the transition zone of the toric contact lens is about 46-55% of an overall area of the toric contact lens.
